(19) United States
(12) Patent Application Publication
(10) Pub. No.: US 2010/0185503 A1
(43) Pub. Date: Jul. 22, 2010

(54) Product Warranties Having a Residual Value

(76) Inventors: Julie Ward Drew, Redwood City, CA (US); Jose Luis Beltran Guerrero, Palo Alto, CA (US); Guillermo Gallego, Waldwick, NJ (US); Ming Hu, Toronto (CA); Ruxian Wang, New York, NY (US); Shailendra K. Jain, Sunnyvale, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/357,840

(22) Filed: Jan. 22, 2009

(51) Int. Cl. G06Q 30/00

(52) U.S. Cl. 705/14.11; 705/500

(57) ABSTRACT

The present disclosure is directed to product warranties having a residual value and a potential rebate based on the residual value. The residual value can thus be inversely related to the number of claims filed against the warranty.

### BACKGROUND

Manufacturers and retailers often offer extended warranties to customers as insurance against future product failures. These warranties are often offered to the customer at the point of sale of new hardware, or during the base warranty period. These optional extended warranties allow the customer to receive support and product repair services that are often above and beyond what is provided by any standard warranty associated with the product.

Certain customers, because of their usage patterns, usage environment, or other factors, may be susceptible to more product failures, and thus may be more expensive to support than other customers. In this situation, a manufacturer will often price an extended at a price that is high enough to offset the expense of these high-usage customers. These higher-cost warranties are often too expensive for low usage customers, and customers who do buy warranties thus end up subsidizing higher usage customers. Uniform pricing deters low-usage customers, and the price may be less than the support cost for high-usage customers.

It may be beneficial for the manufacturer to utilize a mechanism enabling price discrimination based on a customer's expected support costs. If the customer's usage or environment can be observed and measured by the manufacturer, retailer, or third party selling the warranty, then the manufacturer could price discriminate based on these factors. However, it is often difficult and/or costly to measure and verify usage or other environmental factors.

### BRIEF DESCRIPTION OF THE DRAWINGS

FIG. 1 depicts a method for reducing a product warranty cost in accordance with one embodiment of the present disclosure;

FIG. 2 depicts a method of determining the coverage of a claim under a warranty with claim limits according to another embodiment of the present disclosure; and

FIG. 3 depicts a method of determining the issuance of a rebate for a residual value warranty according to yet another embodiment of the present disclosure.

### DETAILED DESCRIPTION OF THE PREFERRED EMBODIMENT(S)

Before the present invention is disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

In describing and claiming the present disclosure, the following terminology will be used in accordance with the definitions set forth below.

It is noted that, as used herein, the singular forms of “a,” “an,” and “the” include plural referents unless the context clearly dictates otherwise. Thus, for example, reference to “a warranty” includes one or more of such warranties, reference to “the product” includes reference to one or more of such products.

As is used herein, the term “product warranty” is used to describe an optional warranty that is purchased and associated with a product in order to cover claims made by the warranty purchaser for service, repairs, and/or replacement of the product during a warranty period.

As is used herein, the term “residual value” refers to a value that is greater than zero.

As used herein, the term “claim limit” refers to a limit on the number of claims that can be filed after which some change in the coverage of a warranty occurs. In one aspect, for example, the residual value of a warranty can ultimately decrease to a zero value if the number of warranty claims filed under the product warranty meets or exceeds a claim limit during the warranty period. In another aspect, a claim limit can refer to a situation where claims filed under the product warranty are ineligible claims and are not covered if the number of warranty claims is greater than the warranty claim limit.

As is used herein, the term “ultimately decreases to” refers to the final value of a variable following a decrease. In situations where zero is the final value, it is required that the decrease be an incremental decrease including at least one intermediate step value between the maximum value and zero. Accordingly, “ultimately decreases to” would not include situations where the value dropped from the maximum value to zero without an intermediate step.

It is noted that by the term “inversely related,” what is meant is that as the number of warranty claims go up, the value of the rebate owed to the customer goes down (at least at one incremental step). As an example, if a warranty costs $200 and there is a claim limit of 3 in place, each of these warranty amounts would be considered to be “inversely related.” e.g., Claim 1—$150 rebate, Claim 2—$100 rebate, Claim 3—$0 rebate; or Claim 1—$200 rebate, Claim 2—$0 rebate, Claim 3—$0 rebate; or Claim 1—$100 rebate; Claim 2—$50 rebate, Claim 3—$1 rebate; or Claim 1—$100 rebate, Claim 2—$50 rebate, Claim 3—$50 rebate, etc.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “up to 1 year,” should be interpreted to include not only the explicitly recited values of 0 to 1 year, but also include individual values and sub-ranges within the indicated range. Thus, included in this numerical range are sub-ranges, such as from 1-3 months, from 2-4 months, and from 0-5 months, etc. This same principle applies to ranges reciting only one numerical value. Furthermore, such an interpretation should apply regardless of the breadth of the range or the characteristics being described.

The present disclosure is directed to product warranties and methods for increasing profitability of warranties by taking into account, at least in part, cost conscious consumers. As described above, when a manufacturer sells an extended warranty priced at a uniform cost to all customers, regardless of usage, low-usage customers are required to subsidize the support costs of high-usage customers. One way to achieve market segmentation and a more equitable pricing with a single warranty product without having to verify usage is through an extended warranty with a residual value. A residual value warranty is one in which the customer may receive a rebate of some portion of the price of the warranty depending on how many claims the customer makes on the product against the warranty.

Accordingly, in one aspect of the present disclosure, a residual value product warranty is provided. Such a warranty can include a product warranty associated with a product, a warranty period within which all eligible claims filed under the product warranty are covered, a residual value that is inversely related to a number of warranty claims filed during the warranty period, and a rebate having a rebate value that is related to the residual value, where the rebate is issued to a warranty owner by a warrantor. In one specific aspect, the rebate may equal the residual value. Numerous warranty periods are contemplated, and as such, the present claims should not be limited thereby. Examples of warranty periods can include those in the range of up to 30 days, up to 60 days, up to 90 days, up to 6 months, up to 1 year, up to two years, up to 5 years, etc. Additionally, warranty period of greater than 5 years are contemplated. In some cases, the duration of the warranty period may be tied to the type of product associated with the warranty. For example, consumer electronics products often can have a shorter warranty period as compared to products having a longer expected usage duration and/or a higher purchase cost, such as an automobile or a home in the case of a home warranty.

A residual warranty thus has a warranty period during which eligible claims made against the purchased product may be supported. As has been described, the residual value is inversely related to the number of warranty claims filed during the warranty period. The rebate provided to the customer at the end of the warranty period is thus based on how many claims have been filed during the warranty period. For example, for a warranty period of [0,T], the refund schedule is shown by Equation (I) for some non-negative integer n:

rₙ≧rₙ₋₁ . . . ≧r₁≧r₀>0 (I)

In one aspect, a customer who makes j≦n claims over the warranty period can receive a rebate of rₙ₋ⱼ. A customer making more than n claims in this scheme would not be eligible to receive a rebate. Thus, in such cases, the residual value warranty contains a claim limit wherein the residual value ultimately decreases to a zero value if the number of warranty claims filed under the product warranty meets or exceeds the warranty claim limit during the warranty period. In some aspects, the residual value can be reduced to a nominal value, where nominal value can include values that are substantially zero compared to the purchase price of the warranty, as compared to the full rebate value, or as compared to any rebate value for a number of claims that is less than the claim limit. An example of a nominal value might be $0.01 or $1, or other small nominal amount (in dollars or other monetary system). Additionally, in some aspects the residual value of the warranty can decrease to a fixed amount that is a value greater than zero, and that is also greater than a nominal value, and thus, still preserves some real value to the warranty user.

Other types of claim limits are additionally contemplated. In one aspect, for example, a warranty can include a claim limit whereby claims filed under the product warranty are ineligible claims and are not covered if the number of warranty claims is greater than the warranty claim limit. Thus, the warranty owner cannot make more claims (or at least receive the benefit of more claims) than is allowed by the claim limit. Subsequent product failures will require the product owner to pay for repairs or other services out-of-pocket. By imposing the various forms of claim limits on a residual value warranty thus allows the warrantor to offer the warranty at a lower up-front price, and thus capture the demand of product purchasers who prefer to pay less up front because they discount the value of a future refund.

Accordingly, if the warranty cost and the refund schedule are designed appropriately, a residual value warranty can be attractive to a low-usage customer. As has been suggested, such a low-usage customer can expect to have few failures and thus to receive a larger rebate. Such a residual value warranty can additionally be attractive to high-usage customers because in many cases, warranty pricing can be comparable to non-residual value warranties. As such, residual value warranties can capture appeal to a broader range of customers, thereby capturing greater market share, and also produce greater profits for the manufacturer.

Numerous types of rebates are contemplated, and it should be noted that the present claims should not be limited by the form of the rebate. In one aspect, for example, the rebate can be provided to the customer as cash or some form of cash. In another aspect, the rebate can be provided to the customer as a credit toward future product or warranty purchases, for example. In another aspect, the rebate can be provided to the customer as a service, such as, for example, extending the duration of the warranty for an additional warranty period. It should be noted that the rebate can be paid to the warranty owner by the warrantor, or it can be paid on behalf of the warrantor by a warrantor's representative.

Furthermore, the rebate can be provided to the customer at the end of the warranty period, any time after the expiration of the warranty period, or during the warranty period. In one specific aspect, for example, the rebate can be provided to the warranty owner during the warranty period as one or more milestone payments. In one specific non-limiting example, the rebate can be paid to the warranty owner as a series of payments made at 6 month intervals. Such a milestone payment scheme can incentivize the warranty owner to pay for small repairs out-of-pocket, or to delay repairs in order to receive the milestone portion of the rebate.

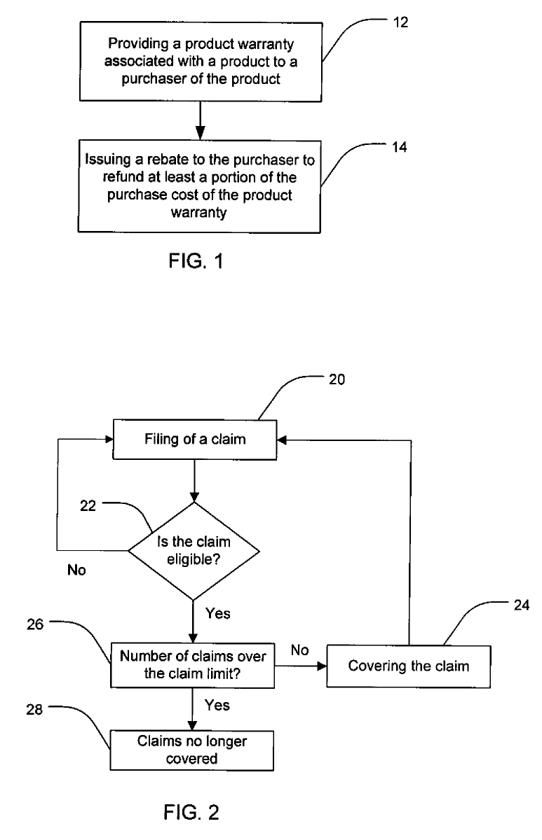

The present disclosure additionally provides methods for reducing the costs associated with product warranties. In one aspect, for example as is shown in FIG. 1, a method for reducing a product warranty cost can include providing a product warranty associated with a product to a purchaser of the product 12, wherein the product warranty has a purchase cost and a warranty period, and issuing a rebate to the purchaser to refund at least a portion of the purchase cost of the product warranty 14, wherein the rebate has a rebate value that is inversely related to a number of warranty claims filed by the purchaser during the warranty period. In one embodiment, the rebase value and the warranty period can be stored on a database, such as a plurality of networked servers.

It is generally intended that all eligible claims are covered under a product warranty. An eligible claim is a claim that is filed under the product warranty during the warranty period that is further considered to be “eligible” by the warrantor of the product warranty. The criteria as to what is “eligible” can be variable depending on a variety of factors, including, without limitation, the nature of the product, they type of damage sustained, warrantor preferences, regional legal requirements, etc. Claim limits used in conjunction with the residual value warranty can affect the eligibility of a claim. In one aspect, for example, the method can include not covering claims filed under the product warranty if the number of warranty claims filed during the warranty period exceeds a warranty claim limit. In other words, claims that are filed in excess of the claim limit can be ineligible claims. For example, FIG. 2 shows a flowchart of a method of determining the coverage of a claim under a warranty with claim limits. In this case, an issue arising with a product results in the filing of a claim 20 under the warranty. A determination is then made as to whether or not the claim is eligible 22. If the claim is eligible, then a determination is made as to whether or not the number of claims filed has exceeded the claim limit of the warranty 26. If the number of claims filed has not exceeded the claim limit of the warranty, the claim is covered under the warranty 24. If the claim is not eligible, but the number of allowed claims has not been exceeded, then future claims can be covered under the warranty. If the number of allowed claims has been exceeded, then claims are no longer covered under the warranty 28.

Claim limits can additionally affect the rebate value, but may or may not render a claim ineligible. For example, in one aspect, the method can further include reducing the rebate value to a value greater than zero if the number of warranty claims filed during the warranty period exceeds a warranty claim limit. Such a value (greater than 0) can include a nominal value, or in other words, an amount that has no real value as compared to the value of the full rebate, the purchase price of the rebate, or any value of rebate for a number of claims that is less than the claim limit. In another aspect, the method can include reducing the rebate value to a zero value if the number of warranty claims filed during the warranty period exceeds a warranty claim limit. In this latter embodiment, reducing the value to a zero value would include an incremental value reduction (e.g., reducing to at least one value greater than zero for at least a first claim) prior to reducing the value to zero.

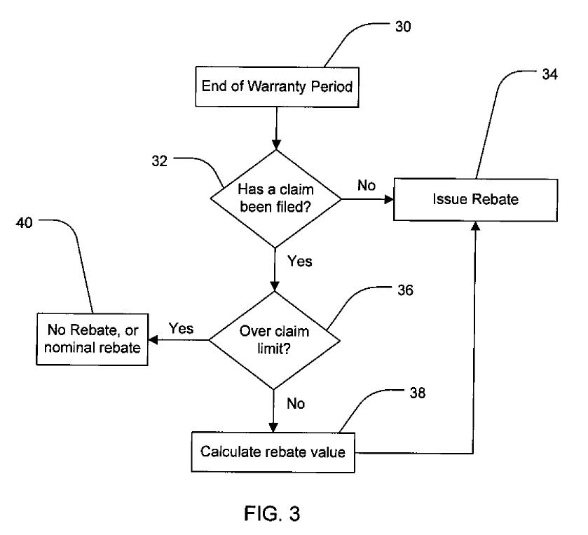

As an example, FIG. 3 depicts a method of determining the issuance of a rebate for a residual value warranty according to one aspect of the present disclosure. At the end of the warranty period 30, a determination is made as to whether or not a claim has been filed 32. If a claim has not been filed, a rebate is issued 34 to the warranty owner. If a claim has been filed, a determination is made as to whether more claims were filed than were allowed by the claim limit of the warranty 36. If the number of claims filed was less than the claim limit of the warranty, then a rebate value is calculated 38, and the rebate is issued to the warranty owner. If the number of claims filed was more than the claim limit, then no rebate, or a nominal rebate is issued 40.

Various methods of estimating pricing of a residual value warranty based on both customer and warrantor expectations are contemplated, and any such estimation method should be considered to be within the present scope. Thus, the following specific descriptions of techniques for accomplishing such pricing should not be seen as limiting.

For the following, assume that the warranty period has a length of T, and time is measured backwards, so t=0 is the end of the warranty period. Thus, a customer is in state (t,k) if there is time t remaining in the warranty period and the customer has k claims remaining out of n total claims of the claim limit (thus the customer has made n−k claims). Calculating a customer's expected value from the residual value warranty can assist the warrantor in pricing a residual value warranty to be attractive to the customer. The customer may affect his expected value from the warranty by strategically absorbing the cost of failures, in order to improve chances of receiving a rebate. For example, let g(t,k) be the maximum expected value of rebate with time t remaining in the warranty period when the customer has k unclaimed service options. Let Cₜ represent the random cost of a service at time t, and λₜ represent the rate at which failures occur at time t. Also δₜ represents an interval of time. Then

g(t,k)=λₜδₜmax(g(t−δₜ,k)−Cₜ,g(t−δₜ,k−1))+(1−λₜδₜ)g(t−δₜ,k)+o(δₜ) (II)

where

Δg(t,k)=g(t,k)−g(t,k−1) (III)

As δₜ↓0, this becomes a differential equation, as shown by Equation (IV):

$$\frac{\partial g ( t , k )}{\partial t} = - {λ}_{t} E [ min ( {C}_{t} , Δ g ( t , k ) ) ] \qquad ( IV )$$

with one boundary condition being:

g(0,k)=rₖ (V)

for k=0, . . . , n.

Another boundary condition can depend on claim limits. For example, for no claim limits:

g(t,k)=0 (VI)

and for a limit of n claims:

$$g ( t , 0 ) = - {\int }_{0}^{t} {λ}_{s} {EC}_{s} d s \qquad ( VII )$$

Accordingly, if a customer with time t remaining in the warranty period and k used claims experiences a failure with repair cost Cₜ, then in order to maximize the expected value the customer should only place a claim for the failure only if:

Cₜ≧Δg(t,k) (VIII)

It can additionally be beneficial to compute the warrantor's or provider's expected costs. For example, let h(t,k) be the provider's expected cost of refund plus support costs for the customer with time t remaining in the warranty period when the customer has k unclaimed service options. If the warranty provider's repair cost is βCₜ for a failure with cost Cₜ, then:

$$\begin{matrix}h ( t , k ) = ( 1 - {λ}_{t} {δ}_{t} ) h ( t - {δ}_{t} , k ) + {λ}_{t} {δ}_{t} \{ P ( {C}_{t} > Δ g ( t , k ) ) E [ β {C}_{t} \vert {C}_{t} > Δ g ( t , k ) ] + h ( t - {δ}_{t} , k - 1 ) ) + P ( {C}_{t} \leq Δ g ( t , k ) ) h ( t - {δ}_{t} , k ) \} + o ( {δ}_{t} ) & ( IX ) \\ where \text{:} & \\ Δh ( t , k ) = h ( t , k ) - h ( t , k - 1 ) & ( X )\end{matrix}$$

with one boundary condition being:

h(0,k)=rₖ (XI)

for k=0, . . . , n. Another boundary condition can depend on claim limits. For example, for no claim limits:

$$h ( t , k ) = β {\int }_{0}^{t} {λ}_{s} {EC}_{s} d s for k < 0 \qquad ( XII )$$

and for a limit of n claims:

h(t,k)=0 (XIII)

for k<0.

This model of calculating warranties is merely one possible model that can be used in accordance with embodiments of the present disclosure. Alternatively, other mathematical models may be used, or warrantors may prefer to determine these residual value warranty schemes more subjectively, e.g., using trial and error or even using special knowledge in a specific area where a warranty is offered. For example, it may be that a company has a smaller number of customers, and thus, intimately knows the usage patterns of its large customers. In such a scenario, using a formulaic mathematical model may not be the best approach in maximizing profit or providing appropriate service to its customers. Conversely, when a warrantor has thousands or even millions of customers, mathematical models or other predictive systems may be more appropriate in determining appropriate residual value schedules for its customers.

While the invention has been described with reference to certain preferred embodiments, those skilled in the art will appreciate that various modifications, changes, omissions, and substitutions can be made without departing from the spirit of the disclosure. It is therefore intended that the invention be limited only by the scope of the appended claims.

What is claimed is:

1. A residual value product warranty, comprising:
a product warranty;
a warranty period within which all eligible claims filed under the product warranty are covered;
a residual value that is inversely related to a number of warranty claims filed during the warranty period; and
a rebate having a rebate value that is related to the residual value, where the rebate is issued to a warranty owner by a warrantor.

2. The warranty of claim 1, wherein the product warranty is associated with a specific product.

3. The warranty of claim 1, further comprising a warranty claim limit, wherein the residual value ultimately decreases to a value greater than zero if the number of warranty claims filed under the product warranty meets or exceeds the warranty claim limit during the warranty period.

4. The warranty of claim 3, further comprising a warranty claim limit, wherein the value greater than zero is a nominal value.

5. The warranty of claim 1, further comprising a warranty claim limit, wherein the residual value ultimately decreases to zero value if the number of warranty claims filed under the product warranty meets or exceeds the warranty claim limit during the warranty period.

6. The warranty of claim 1, further comprising a warranty claim limit, wherein warranty claims filed under the product warranty are ineligible claims and are not covered if the number of warranty claims is greater than the warranty claim limit.

7. The warranty of claim 1, wherein the rebate is issued to the warranty owner after termination of the warranty period.

8. The warranty of claim 1, wherein the rebate is issued to the warranty owner during the warranty period.

9. The warranty of claim 8, wherein the rebate is issued to the warranty owner as milestone payments during the warranty period.

10. The warranty of claim 1, wherein the residual value remains substantially unchanged prior to the filing of at least a second claim.

11. The warranty of claim 1, wherein the residual value product warranty rebate values are determined for a product using mathematical modeling.

12. The warranty of claim 1, wherein the residual value product warranty rebate values are determined subjectively.

13. A method for increasing profitability of a warranty, comprising:
issuing a product warranty to a purchaser of a product, wherein the product warranty has a purchase cost and a warranty period which are stored in a database; and
issuing a rebate to the purchaser to refund at least a portion of the purchase cost of the product warranty, wherein the rebate has a rebate value that is inversely related to a number of warranty claims filed by the purchaser during the warranty period.

14. The method of claim 13, further comprising covering all eligible claims filed under the product warranty during the warranty period.

15. The method of claim 13, further comprising not covering claims filed under the product warranty if the number of warranty claims filed during the warranty period exceeds a warranty claim limit.

16. The method of claim 13, further comprising reducing the rebate value to a minimum rebate value or nominal rebate value if the number of warranty claims filed during the warranty period exceeds a warranty claim limit.

17. The method of claim 13, further comprising reducing the rebate value to zero value if the number of warranty claims filed during the warranty period exceeds a warranty claim limit.

18. The method of claim 13, wherein the rebate is determined in accordance with a residual value product warranty rebate schedule, said schedule determined using mathematical modeling.

19. The method of claim 13, wherein the rebate is determined in accordance with a residual value product warranty rebate schedule, said schedule determined subjectively.

20. The method of claim 13, wherein the database comprises a plurality of networked servers.
